(19) United States
(12) Patent Application Publication
(10) Pub. No.: US 2008/0168500 A1
(43) Pub. Date: Jul. 10, 2008

(54) SYSTEM AND METHOD TO AUTOMATICALLY CHANGE THE CHANNEL TO A PREDEFINED CHANNEL DURING COMMERCIALS

(76) Inventors: Michael P. Carlson, Austin, TX (US); Linda A. Lisle, Cedar Park, TX (US); Herman Rodriguez, Austin, TX (US)

Correspondence Address: Greg Goshorn, P.C., 9600 Escarpment, Suite 745-9, AUSTIN, TX, 78749, US

(21) Appl. No.: 11/619,712

(22) Filed: Jan. 4, 2007

(51) Int. Cl. G06F 3/00

(52) U.S. Cl. 725/46

(57) ABSTRACT

Provided is a method for controlling a media device such that a user can define specific events as interruptions and automatically change the channel when one of these events is detected. The media control device (MCD) is configurable, both respect to the type of event that is considered an interruption and the alternate channel(s) to which the media device is changed. Once the interrupt has concluded, the MCD changes the radio back to the original station. In the alternative, during an interruption the MCD may simply replace the interrupted channel with a stream from another device. Introduction of a short time delay between the reception of a media signal and the presentation of the signal to a user enables the MCD to execute the described functions in a manner that appears seamless to the user.

### TECHNICAL FIELD

The present invention relates generally to multimedia and, more specifically, to a method for automatically changing channels in specified situations.

### BACKGROUND OF THE INVENTION

In the world today, there are many different streams, or channels, of information and entertainment. In order to fund programming, many channels bombard the listener or viewer with commercials. For example, many television stations display several minutes of commercials in conjunction with each half hour of programming. Radio stations typically play a few songs and then interrupt the music with commercials, announcements or the conversation of a disk jockey. Many consumers find these interruptions annoying.

Consumers typically respond to the interruption of programming in one of several ways. The time that the media outlet is displaying commercials is sometimes used to perform an errand such as retrieving food from the kitchen. Another common response is changing the channel. If a new channel is also displaying a commercial, the user might even change to a third or fourth channel. This type of activity is often referred to a “channel surfing.”

What is needed is a method of providing the user with more control over the media. For example, it would be beneficial to have a device that could be programmed with a list of prioritized alternative media channels such that, when a commercial, announcement, conversation or other type of defined interruption is detected, the media device changes to an alternative channel. If another defined interruption is detected on the new channel, it would be beneficial for the device to keep searching through the prioritized list of channel until an acceptable channel is detected. Further, it would be beneficial if the media device described above would had the capacity to monitor the original channel and automatically change to the original channel once the interruption is over.

### SUMMARY OF THE INVENTION

Provided is a method for controlling a media device such that a user can define specific events as interruptions and automatically change the channel when one of these events is detected. The media control device (MCD) is configurable, both respect to the type of event that is considered an interruption and the alternate channel(s) to which the media device is changed. For example, during commercials in a television program, the media control device could change to a weather channel for the duration of the commercial. Once the commercials have concluded on the original channel, the MCD changes the television back to the original channel.

With respect to radio stations, for example, any defined period without music might be defined as an interruption. In this manner, a listener could employ the MCD to screen commercials, announcements, the speaking of a disk jockey or other defined interruption. A MCD according to the claimed subject matter detects the interruption and changes the channel to a predefined alternative station. If the alternative station is also in the middle of an interruption, the MCD proceeds through the predefined list of available station until an acceptable station is found. Once the interrupt has concluded, the MCD changes the radio back to the original station. In the alternative, during an interruption the MCD may simply replace the interrupted channel with a stream from another device such as, but not limited to, music from a CD/DVD player.

By scanning both the current station and potential, defined alternative channels, a transition may be effected without the user detecting any delay. Introduction of a short time delay between the reception of a media signal and the presentation of the signal to a user enables the MCD to execute the described functions in a manner that appears seamless to the user. For example, during a two second delay, the MCD detects an interruption on a channel or station, scans alternative channels or stations for acceptability and changes the media device before the delay has concluded. In this manner, the user does not need to listen to either the interruption or silence while the MCD is executing the scan and change functions. In a similar fashion, when the original interruption has concluded, the short time delay enables the MCD to seamlessly transition back to the original channel.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures.

FIG. 1 is an exemplary multimedia system architecture that includes a media control device (MCD), implemented according to the claimed subject matter.

FIG. 2 is a block diagram of the MCD of FIG. 1 in more detail.

FIG. 3 is an exemplary AlternativeChannelDescriptorObject (ACDO) memory object employed in one implementation of the claimed subject matter.

FIG. 4 is a flowchart of an exemplary Initiate Media Control Device Logic (MCDL) process for implementing one aspect of the claimed subject matter.

FIG. 5 is a flowchart of an exemplary Execute MCDL process for implementing one aspect of the claimed subject matter.

FIG. 6 is a flowchart of an exemplary Add Trigger process for implementing one aspect the claimed subject matter.

### DETAILED DESCRIPTION OF THE FIGURES

Although described with particular reference to an automatic television channel surfing system, the claimed subject matter can be implemented in any media access system in which the elimination or mitigation of interruptions is desirable. Those with skill in the relevant arts will recognize that the disclosed embodiments have relevance to a wide variety of media and computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for the elimination of undesirable programming from a particular media stream. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

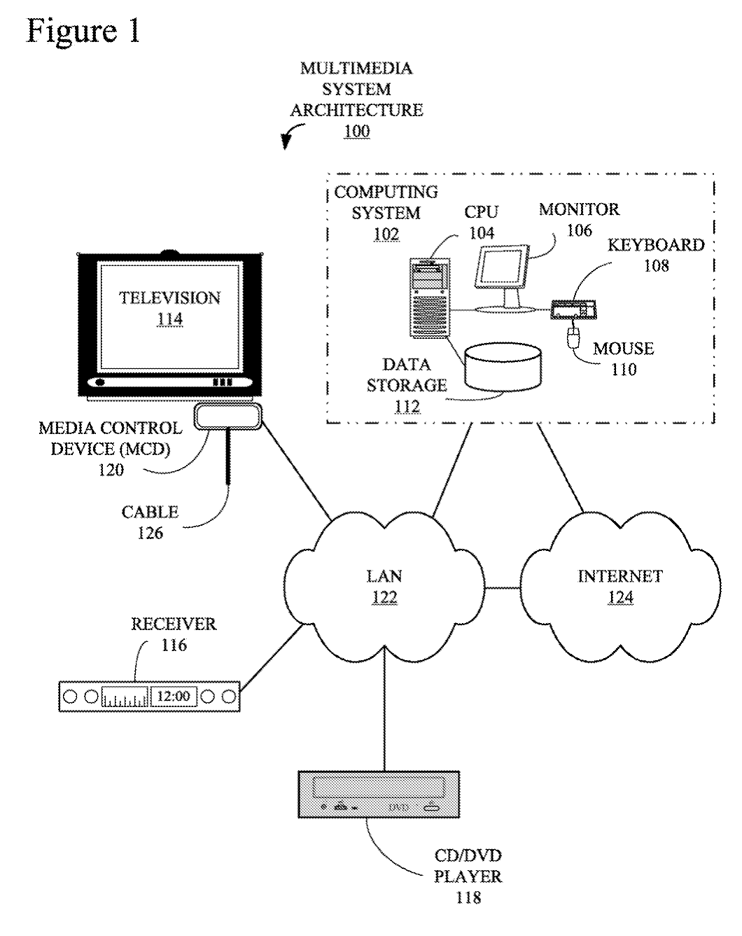

FIG. 1 is an exemplary multimedia system architecture 100 that includes a media control device (MCD) 120, implemented according to the claimed subject matter. Architecture 100 includes several devices, including a computing system 102, a television 114, a receiver 116 and a CD/DVD player 118. Devices 102, 114, 116, 118 and MCD 120 are communicatively coupled to a local area network (LAN) 122. In this example, television 114 is coupled to a cable 126 via MCD 120. Cable 126 transmits content to television 114 for viewing.

The connections between LAN 122 and devices 102, 114, 116, 118 and MCD 120 may be, but are not limited to, direct, wired connections, wireless connections or via a LAN hub (not shown). LAN 122 and computing system 102 are also coupled to the Internet 124. Each of devices 114, 116, 118 and 120 may also be communicatively coupled to Internet 124 via LAN 122, computing system 102 or both. Those with skill in the computing and communication arts should appreciate that there are many possible methods for connecting devices to each other in addition to LAN 122 and the Internet 124. The elements of FIG. 1 are used only for the purposes of describing the claimed subject matter and are not intended to limit the claims.

It should be noted that, although devices 102, 114 116 and 118 and 120 are illustrated as separate devices, a large degree of integration is possible. For example, the functionality of MCD 120 may be incorporated into computing system 102, television 114 and/or receiver 116. In this example MCD 120 is illustrated as closely coupled with television 114, although devices like MCD 120 could also be coupled to receiver 116. In addition, the recording and playback capabilities of CD/DVD player 118 may be incorporated into television 114 and/or receiver 118. Those with skill in the relevant arts should appreciate the extent to which the capabilities of such devices are currently, and may be, integrated into single units or separated into separate, yet connected components.

Computing system 102 includes a central processing unit (CPU) 104, coupled to a monitor 106, a keyboard 108 and a mouse 110, which together facilitate human interaction with computer 102. Also included in computer 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown).

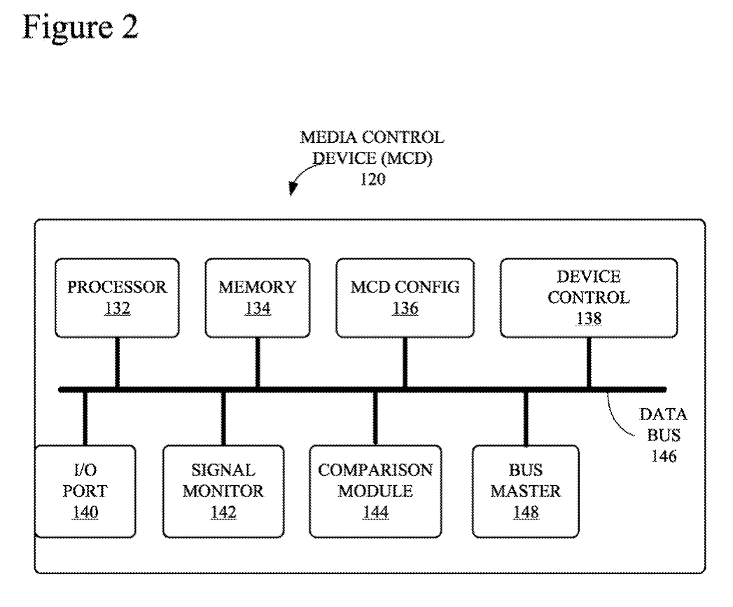

In this example, television 114 and receiver 116 are Internet-enabled or, in other words, are able to download an appropriate signal from Internet 124 via LAN 122. MCD 120 is configured to monitor and process the types of signals employed by television 114, which in this example, are received via a cable 126 and LAN 122. MCD 120 is also configured to send control signals to television 114, receiver 116 and CD/DVD player 118. The setup, operation and purpose of the control signals from MCD 120 to devices 114, 116 and 118 are described in more detail below in conjunction with FIGS. 2-6.

FIG. 2 is a block diagram of MCD 120 of FIG. 1 in more detail. Functional modules include a processor 132, a memory 134, a MCD configuration (config.) module 136, a device control module 138, an Input/Output (I/O) port 140, a signal monitor 142 and a comparison module 144. Each of modules 132, 134, 136, 138, 140, 142 and 144 are coupled to a data bus 146, which enables modules 132, 134, 136, 138, 140 and 142 to communicate with each other. Traffic on data bus 146 is controlled by a bus master 148.

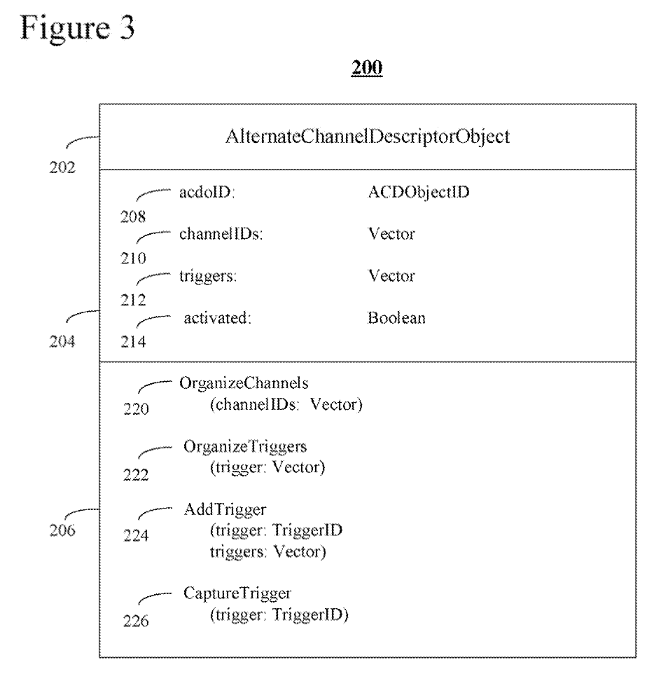

Processor 132 controls the coordination of modules 134, 136, 138, 140, 142 and 144 while executing the claimed subject matter. Memory 134 provides storage for data and executables employed by processor 132. MCD configuration module 136 provides involatile storage for information employed in the claimed subject matter. An example of a memory object stored in module 136 is described below in conjunction with FIG. 3. Simply stated, module 136 stores information related to devices, such as television 114 and receiver 116 of FIG. 1, and media streams to be monitored and information on defined interruptions, or “triggers,” and associated actions to be executed in appropriate circumstances based upon the results of the monitoring. The monitoring of devices and streams is described in more detail below in conjunction with FIGS. 3-6.

Device control 138 stores information relating to the devices, such as television 114, receiver 116 and CD/DVD player 118 (FIG. 1), of architecture 100 (FIG. 1) that may receive a control signal from MCD 120 based upon the triggers detected and associated actions. Specifically, device control 138 stores information relating to the formatting of commands to target devices. Examples of types of commands include, but are not limited to, commands to switch channels on the targeted devices and, in the case of CD/DVD player 118, a command to play a particular selection from a CD or DVD.

Input/Output (I/O) port 140 handles communication between MCD 120 and target devices. In addition, I/O port 140 transmits signals from cable 126 (FIG. 1) to the appropriate device in architecture 100. Signal monitor 142 picks out specific signals to monitor based upon information stored in an AlternateChannelsDescriptor object 200 (see FIG. 3). Comparison module 144 compares streams selected for monitoring by module 142 to data stored in corresponding instances of data object 200 to determine if a particular trigger, or in this example a commercial, is present on the particular channel. There are several possible types of comparisons. For example, module 144 may have sound processing logic for making a determination that a commercial has begun by detecting a change in the average sound level. Another example of possible commercial detection method is to collect a digital signature corresponding to each commercial. In other words, the user transmits a command to MCD 120 that a particular broadcast segment is a commercial; MCD 120 computes a signature corresponding to a period of time at the beginning of the commercial; and MCD 120 stores the signature for later comparisons. In this manner, the claimed subject matter enables a user to filter some commercials and enable others.

In an alternative embodiment, MCD 120 detects transitions in the media stream, computes a digital signature corresponding to a short period of time at the beginning of each transition, and marks a particular digital signature as corresponding to an interruption such as a commercial. The detected interruption then triggers a transition from one channel to another once the signature has been detected a predetermined number of times. In another embodiment, a commercial or other type of interruption may be detected based upon information transmitted in conjunction with a particular media stream. MCD 120 may use any combinations of approaches to detect interruptions, including any techniques that have yet to be developed. In other words, the claimed subject matter is not limited to these examples but includes any currently available or yet to be developed method for analyzing a media or information stream for potential triggers.

FIG. 3 is an exemplary AlternateChannelDescriptorObject (ACDO) memory object 200 employed in one implementation of the claimed subject matter. ACDO memory object 200 includes a title section 202, which merely states the name of object 200, i.e. “AlternateChannelDescriptorObject,” an attribute section 204, which contains memory elements, or attributes, associated with ACDO memory object 200, and a method section 206, which includes functions, or methods, that may be executed in conjunction with ACDO memory object 200. It should be noted that the attributes and methods described are used for the purpose of illustration only. Additional and/or different attributes and methods may be employed to implement the claimed subject matter.

Attribute section 202 includes an “acdoID” attribute 208, a “channelIDs” attribute 210, a “triggers” attribute 212 and an “activated” attribute 214. Instantiations of object 200 are stored in MCD config 136 (FIG. 2) of MCD 120 (FIGS. 1 and 2).

AcdoID attribute 208 is a variable of type ACDObjectID that contains a reference to the particular instance of object 200. Each instance of object 200 has a unique value for attribute 208 that allows each instance to be uniquely identified. ChannelIDs attribute 210 is a variable of type Vector that stores a list of alternative channels or media streams. Examples of possible media streams are different channels received by television 114 (FIG. 1) or selected radio stations received by receiver 116 (FIG. 1). In the following example, a channel might be associated with an Internet 124 (FIG. 1) domain providing streaming media, a channel associated with cable 126 (FIG. 1) or a broadcast radio or television station.

Trigger attribute 212 is a variable of type Vector that stores a record of events, or triggers, that a user has configured MCD 120 to detect on the channels stored in attribute 210. Logic associated with any particular trigger is typically stored in memory 134 and executed on processor 132, although specialized functions associated with a particular trigger may be stored and/or executed on one of the specialized modules 138, 140, 142, 144 and 148 (FIG. 2).

Activated attribute 214 is a variable of type Boolean that stores a value indicating whether or not the ACDO object associated with acdoID 208 is currently active. In other words, MCD 120 provides the ability to define channels and triggers associated with particular devices that may be executed in the future but are currently inactive.

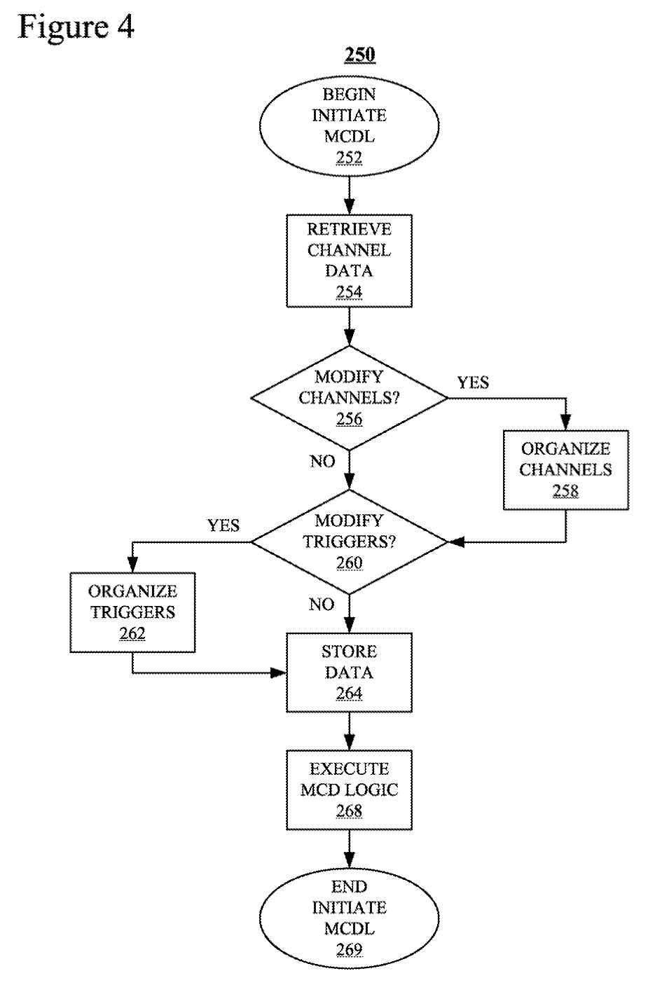

Method section 206 of object 200 includes four (4) exemplary functions, or methods; i.e. an “OrganizeChannels” method 220, an “OrganizeTriggers” method 222, an “Addtrigger” method 224 and a “CaptureTrigger” method 226. Methods 220, 222, 224 and 226 are described in more detail below in conjunction with FIGS. 4-6. Simply stated, OrganizeChannels method 220 is executed in conjunction with a graphical user interface (GUI) (not shown) that enables a user to add to, delete from and prioritize channels stored in channelIDs attribute 210. OrganizeTriggers method 222 is executed in conjunction with a graphical user interface (GUI) (not shown) that enables a user to add, delete, activate and deactivate specific triggers referred to in triggers attribute 212. AddTrigger method 224 is executed to add a designated interruption to the list of trigger stored in triggers attribute 212. CaptureTrigger method 226 is executed to store information about a particular event so the event can be identified as a trigger in the future.

Only four methods are illustrated for the sake of simplicity. Those with skill in the programming arts should appreciate that an object such as object 200 would typically include many additional methods including, but not limited to, constructors, destructors, and methods to set and get values for various attributes. It should be understood that ACDO object 200 is only one example of a memory object that may be used to implement the claimed subject matter. Other memory objects with fewer, more and/or different attributes and methods may be employed. In addition, there are many ways other than employing object 200 to implement the functionality and data storage of the claimed subject matter. For example, the claimed subject matter may be implemented by means of a computer program in conjunction with a relational database.

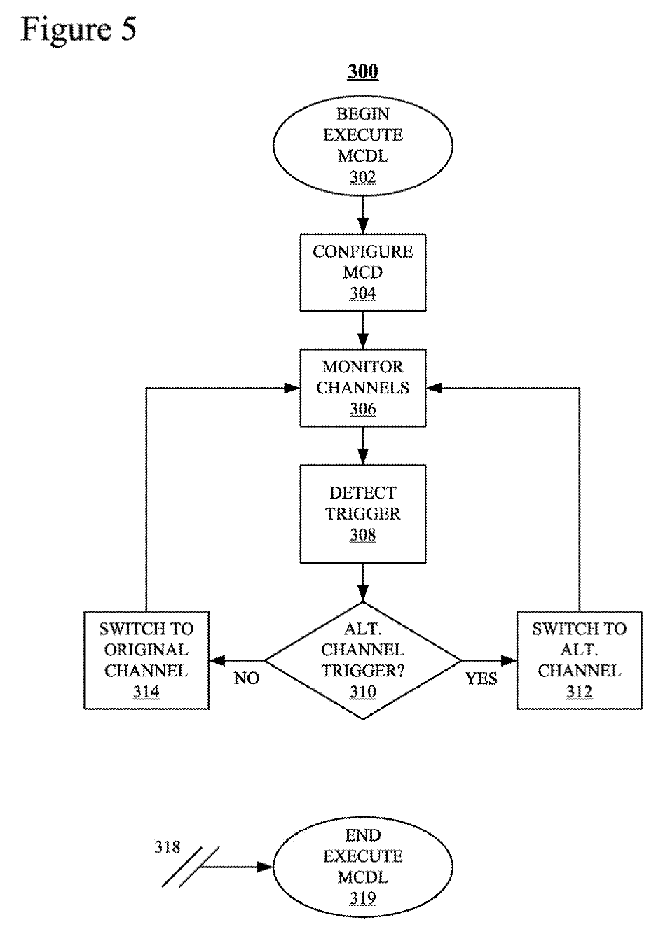

FIG. 4 is a flowchart of an exemplary Initiate Media Control Device Logic (MCDL) process 250 for implementing one aspect of the claimed subject matter. Process 250 loads, configures and initiates an “Execute Media Control Device Logic (MDCL)” process 300 described below in conjunction with FIG. 5. Process 250 is stored in memory 134 (FIG. 2) and executed on processor 132 (FIG. 2) of MCD 120 (FIGS. 1 and 2).

Process 250 starts in a “Begin Initiate Media Control Device Logic (MDCL)” block 252 and proceeds immediately to a “Retrieve Channel Data” block 254. During block 254, process 250 retrieves from memory 134 an ACDO memory object 200 corresponding to the media device that is controlled in accordance with the claimed subject matter, which in this example is television 114 (FIG. 1). It should be noted that there may be more than one memory object 200 corresponding to any particular device and, although not shown, methods for either the user to manually specify or MCD 120 to automatically determine the appropriate memory object 200 for a particular circumstance are provided. For example, a user may have one memory object 200 for the viewing of sporting events and another object 200 for the viewing of old movies. In a sporting event scenario, alternate channel(s) may consist of other sports channels on television 114 and, in a movie channel scenario, the alternative channel(s) may be, for example, a weather channel on television 114, a radio station from receiver 116 (FIG. 1) or a musical selection from CD/DVD player 118 (FIG. 1).

During a “Modify Channels?” block 256, process 250 offers the user an option to setup and organize channel information stored in conjunction with memory object 200, which was retrieved during block 254. If the user elects to modify memory object 200, process 250 proceeds to an “Organize Channels” block 258. During block 258, process 250 executes OrganizeChannels method 220, which, as described above in conjunction with FIG. 3, provides access to a GUI (not shown) that enables the user to add channels to, delete channels from and prioritize the alternative channels stored in channelIDs attribute 210 of the memory object 200 retrieved from memory 134 during block 254.

If the user elects not to organize channels during block 256 or has finished organizing channels during block 258, process 250 proceeds to a “Modify Triggers?” block 260. During block 260, process 250 offers the user an option to setup and organize trigger information stored in conjunction with the memory object 200 retrieved during block 254. If the user elects to modify triggers attribute 212 of memory object 200, process 250 proceeds to an “Organize Triggers” block 262. During block 262, OrganizeTriggers method 222 (FIG. 3) is executed in conjunction with a graphical user interface (GUI) (not shown) that enables a user to add, delete, activate and deactivate specific triggers referred to in triggers attribute 212. As explained above in conjunction with triggers attribute 212 of FIG. 3, trigger information comprises any information necessary for comparison module 144 (FIG. 2) to determine that an interruption has occurred, regardless of the type of interruption of the method employed to detect the interruption.

Following the modification of trigger information during block 262 or the decision not to modify the trigger information during block 260, process 250 proceeds to a “Store Data” block 264. During block 264, process 250 stores memory object 200, if modified, in memory 134. During an “Execute MCDL” block 266, process 250 initiates an “Execute Media Control Device (MCD) Logic” process 300, which is described below in conjunction with FIG. 5. Finally, process 250 proceeds to an “End Initiate MCDL” block 269 in which process 250 is complete.

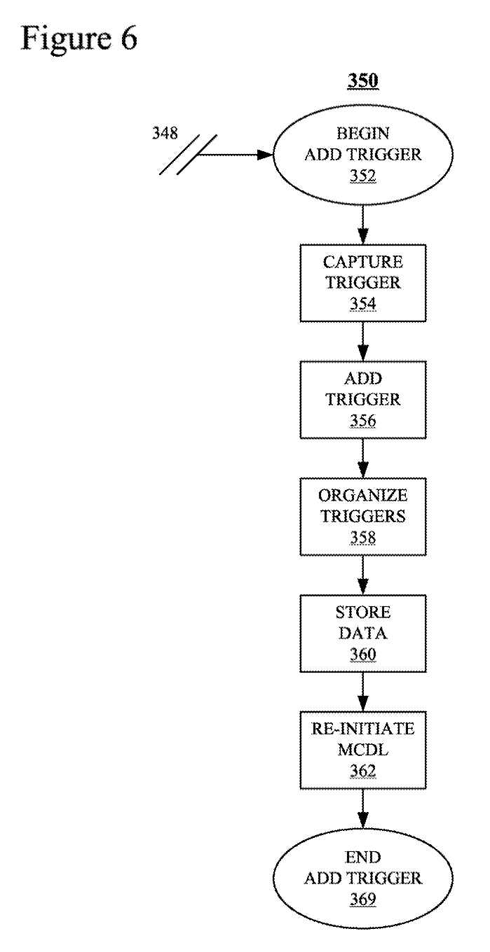

FIG. 5 is a flowchart of exemplary Execute Media Control Device Logic (MCDL) process 300 for implementing one aspect of the claimed subject matter. Process 300 is stored in memory 134 (FIG. 2) and executed on processor 132 (FIG. 2) of MCD 120 (FIGS. 1 and 2). As noted in conjunction with FIG. 4, process 300 is initiated by Execute MCD Logic block 268 of Initiate MCDL process 250. Process 300 may also be initiated by an “Add Trigger” process 350, described below in conjunction with FIG. 6.

Process 300 starts in a “Begin Execute MCDL” block 302 and proceeds immediately to a “Configure MCD” block 304. During block 304, process 300 loads executable code (not shown) and employs ACDO memory object 200 (FIG. 3) retrieved during Retrieve Channel Data block 254 (FIG. 4) of process 250 to configure the loaded code. During a “Monitor Channels” block 306, process 300 scans channels identified in channelIDs attribute 210 (FIG. 3) for triggers identified in triggerIDs attribute 212 (FIG. 3), both of which are part of ACDO memory object 200. Block 306 is facilitated by specialized logic in signal monitor module 142 (FIG. 2) and comparison module 144 (FIG. 2) of MCD 120.

During a “Detect Trigger” block 308, process 300 has detected a trigger during block 306. As explained above in conjunction with FIGS. 3 and 4, there are many different types of triggers depending upon the configuration of MCD 120 and the particular device that is being monitored. One type of trigger that has not been described, is a “resumption” trigger associated with the resumption of programming on the original channel. In other words, once an alternate channel is displayed, MCD 120 monitors the original channel to determine when the interruption that caused a switch to begin with has concluded. The end of the original interruption creates a trigger that, as explained below, returns the media device to the original channel.

During an “Alternate (Alt.) Channel Trigger?” block 310, process 300 determines whether or not the trigger detected during block 308 is resumption trigger or a typical “alternate channel” trigger that indicates that a switch to an alternate channel is appropriate. If the trigger is an alternate channel trigger, process 300 proceeds to a “Switch to Alt. Channel” block 312 during which process 300 changes the channel to the next alternate channel stored in channelIDs attribute 210. If the detected trigger is not an alternate channel trigger, i.e. the trigger a resumption trigger, process 300 proceeds to a “Switch to Original Channel” block 314. During block 314, process 300 returns television 114 to the original channel.

Following blocks 312 and 314, process 300 returns to block 306 in which processing continues as described above. It should be noted that, once television 114 has been switched to an alternate channel during block 312, process 300 iterates through blocks 306, 308, 310 and 312 until a next alternate channel free of defined interruptions is located.

Finally, when an asynchronous interrupt 318 is executed, process 300 proceeds to an “End Execute MCDL” block 319 in which process 300 is complete. Asynchronous interrupt 318 is employed to terminate process 300 because in typical operation process 300 executes continuously once initiated. Events that cause interrupt 318 include, but are not limited to, a power-off of MCD 120 and the execution of Add Trigger process 350 (FIG. 6).

FIG. 6 is a flowchart of exemplary Add Trigger process 350 first introduced above in conjunction with FIG. 5. Process 350 is stored in memory 134 (FIG. 2) and executed on processor 132 (FIG. 2) of MCD 120 (FIGS. 1 and 2). Typically, process 350 is initiated by an asynchronous interrupt 348, generated by a user who, while in the midst of viewing television 114, transmits a control signal to MCD 120 to indicate that the current programming should be defined as an interrupt. The signal may be transmitted by an input on television 114 or by entry of a command or series of commands on a remote control device (not shown) associated with television 114. Asynchronous interrupt causes an interrupt service routine (ISR) (not shown) to be executed that initiates process 350.

Once asynchronous interrupt 348 is received, process 350 starts in a “Begin Add Trigger” block 352 and proceeds immediately to a “Capture Trigger” block 354. During block 354, MCD 120 executes logic to determine an identifier for the interruption that caused the user to transmit interrupt 348. Block 354 corresponds to CaptureTrigger method 226 introduced above in conjunction with FIG. 3. Depending upon the particular device and types of interruptions encountered, the captured information necessary to identify the interruption in the future may vary. For example, process 350 may take a digital signature of the interruption, note that the interruption is associated with a particular sound level change or note that a transition in the either a digital stream that carries the programming signal or an information stream that accompanies the signal has occurred.

During an Organize Triggers block 358, OrganizeTriggers method 222 (FIG. 3) is executed in conjunction with a graphical user interface (GUI) (not shown) that enables a user to activate or deactivate the identified trigger. During a “Store Data” block 360, process 350 stores the trigger information captured during block 354 into triggers attribute 212 (FIG. 3) of memory object 200 (FIG. 3) in memory 134 (FIG. 2). As explained above in conjunction with triggers attribute 212 of FIG. 3, trigger information comprises any information necessary for comparison module 144 (FIG. 2) to determine that an interruption has occurred, regardless of the type of interruption of the method employed to detect the interruption.

During a “Re-Initiate MCDL” block 362, process 350 transmits asynchronous interrupt 318 (FIG. 5) to the currently executing process 300 and then re-initiates process 300 so that the new trigger information stored in memory object 200 can be implemented. Finally, process 350 proceeds to an “End Add Trigger” block 369 in which process 350 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for switching a media device among alternative channels, comprising:
defining a list of channels corresponding to a media device and a corresponding user preference for switching channels among the list of channels;
defining an interruption corresponding to media streams presented on the media device;
presenting the first channel on the media device;
detecting the interruption on the first channel; and
presenting a second channel on the media device of the list of channels, based upon the user preference, when the interruption is detected on the first channel.

2. The method of claim 1, further comprising:
defining a second list of channels corresponding to the media device and a corresponding second user preference for switching channels among the second list of channels; and
providing a user interface for selecting for presentation on the media device a choice between channels of either the first list and the second list.

3. The method of claim 1, further comprising:
detecting the interruption on the second channel;
presenting on the media device a third channel of the list of channels, based upon the user preferences, when the interruption is detected on the second channel.

4. The method of claim 1, further comprising:
detecting an end of the interruption on the first channel; and
switching the media device from the second channel to the first channel when the end of the interruption on the first channel is detected.

5. The method of claim 1, wherein the second channel is a programming stream from a device other then the media device.

6. The method of claim 1, wherein the media device is a television and the interruption is a commercial.

7. The method of claim 1, wherein the media device is a radio receiver and the interruption is a non-musical interlude between musical selections.

8. A device for switching a media device among alternative channels, comprising:
a list of channels corresponding to a media device;
a corresponding user preference for switching channels among the list of channels;
logic for detecting an interruption corresponding to media streams presented on the media device;
logic for switching the media device from a first channel of the list of channels to a second channel of the list of channels, based upon the user preference, when the interruption is detected on the first channel.

9. The device of claim 8, further comprising:
a second list of channels corresponding to the media device and a corresponding second user preference for switching channels among the second list of channels; and
a user interface for selecting the first list or the second list for presentation on the media device and for switching between channels on either the first list and the second list, respectively, based upon the first user preference or the second user preference, respectively.

10. The device of claim 8, further comprising:
logic for detecting the interruption on the second channel;
logic for switching the media device from the second channel to a third channel of the list of channels, based upon the user preferences, when the interruption is detected on the second channel.

11. The device of claim 1, further comprising:
logic for detecting an end of the interruption on the first channel; and
logic for switching the media device from the second channel to the first channel when the end of the interruption on the first channel is detected.

12. The device of claim 8, wherein the second channel is a programming stream from a device other then the media device.

13. The device of claim 8, wherein the media device is a television and the interruption is a commercial.

14. The device of claim 8, wherein the media device is a radio receiver and the interruption is a non-musical interlude between musical selections.

15. A computer programming product for switching a media device among alternative channels, comprising:
a memory;
logic, stored on the memory, for defining a list of channels corresponding to a media device and a corresponding user preference for switching channels among the list of channels;
logic, stored on the memory, for defining an interruption corresponding to media streams presented on the media device;
logic, stored on the memory, for presenting on the media device the first channel;
logic, stored on the memory, for detecting the interruption on the first channel; and
logic, stored on the memory, for presenting on the media device a second channel of the list of channels, based upon the user preference, when the interruption is detected on the first channel.

16. The computer programming product of claim 15, further comprising:
logic, stored on the memory, for defining a second list of channels corresponding to the media device and a corresponding second user preference for switching channels among the second list of channels; and
logic, stored on the memory, for providing a user interface for selecting for presentation on the media device a choice between channels on either the first list or the second list.

17. The computer programming product of claim 15, further comprising:
logic, stored on the memory, for detecting the interruption on the second channel;
logic, stored on the memory, for presenting on the media device a third channel of the list of channels, based upon the user preferences, when the interruption is detected on the second channel.

18. The computer programming product of claim 15, further comprising:
logic, stored on the memory, for detecting an end of the interruption on the first channel; and
logic, stored on the memory, for switching the media device from the second channel to the first channel when the end of the interruption on the first channel is detected.

19. The computer programming product of claim 15, wherein the media device is a television and the interruption is a commercial.

20. The computer programming product of claim 15, wherein the media device is a radio receiver and the interruption is a non-musical interlude between musical selections
